(19) United States
(12) Patent Application Publication
(10) Pub. No.: US 2023/0169568 A1
(43) Pub. Date: Jun. 1, 2023

(54) MEMORY ARCHITECTURE AND KIOSK FOR PROVIDING RECOMMENDATION SERVICE USING THE SAME

(71) Applicant: KOREA INSTITUTE OF SCIENCE AND TECHNOLOGY, Seoul (KR)

(72) Inventors: Juyoun PARK, Seoul (KR); Ig Jae KIM, Seoul (KR); Junghyun CHO, Seoul (KR); Heeseung CHOI, Seoul (KR); Haksub KIM, Seoul (KR); Gi Pyo NAM, Seoul (KR); Haesol PARK, Seoul (KR); Hyungjoo JUNG, Seoul (KR)

(73) Assignee: KOREA INSTITUTE OF SCIENCE AND TECHNOLOGY, Seoul (KR)

(21) Appl. No.: 17/673,965

(22) Filed: Feb. 17, 2022

(30) Foreign Application Priority Data
Nov. 30, 2021 (KR) 10-2021-0168413

(51) Int. Cl. G06Q 30/06

(52) U.S. Cl. CPC G06Q 30/0631; G06Q 30/0633

(57) ABSTRACT

A kiosk for providing a recommendation service according to an embodiment displays an orderer's past ordered product as a recommended product on the screen of the kiosk, the past ordered product read based on a similarity calculation result between a current input attribute representing a contextual feature of a current order status and a past input attribute stored in memory.

### CROSS-REFERENCE TO RELATED APPLICATION

This application claims the benefit of priority to Korean Patent Application No. 10-2021-0168413 filed in the Korean Intellectual Property Office on Nov. 30, 2021, the entire contents of which are incorporated herein by reference.

### TECHNICAL FIELD

The disclosed embodiments relate to technology for providing a recommendation service using memory architecture.

### BACKGROUND ART

As the development of technologies enables the rise of contactless services, the demand for unmanned kiosks is increasing to save the costs and prevent infectious diseases. However, middle-aged people and older people have many difficulties in using unmanned kiosks, and for example, they spend a large amount of time in using unmanned kiosks or fail to select desired menus. It is because a service offered by kiosks puts aside the convenience of conversational ordering, and tends to focus on the goal of product ordering.

To make up for the absence of staffs, the kiosks need to be capable of having conversation with orderers as staffs do so. Further, the kiosks may enhance the ordering convenience when they offer product recommendation services for each order by making use of computing speed and storage capability of machine.

The related chatbots or recommendation services are being widely used in various fields. However, providing such services requires lots of training data related to users' histories.

For this reason, when the existing recommendation services are applied to unmanned kiosks, product recommendations are difficult for the unmanned kiosks which do not store lots of ordering histories. Moreover, the existing recommendation services do not consider situations in which users are placed, so the recommended content may be unsuitable for the users depending on the situations.

Accordingly, there is a need for systems for providing services for user convenience by making use of even a single experience. Additionally, for better services, the surrounding situations related to users should be considered when offering the services.

### DISCLOSURE

### Technical Problem

The disclosed embodiments are directed to providing a recommendation service using memory architecture.

### Technical Solution

A method for providing a recommendation service based on a kiosk according to an embodiment is a method performed by a computing device including memory which stores one or more processors; and one or more programs which are executed by the one or more processors, and stores a pair of an input attribute representing an order status of each orderer at the time of order and a product ordered by each orderer, and the method comprising: receiving a current input vector including one or more current input attributes representing a context feature of a current order status; reading a read vector including the orderer's past ordered product by applying a weight corresponding to the current input attribute to a similarity calculation result between each current input attribute of the current input vector and each past input attribute stored in the memory; and displaying a recommended product to the orderer on a screen of the kiosk occupied by the orderer based on the past ordered product in the read vector.

The one or more current input attributes may include at least some of the orderer's facial identity, look, emotion, age, gender, time when the orderer is detected and weather at the time of current order, and each past input attribute may include at least some of the orderer's facial identity, look, emotion, age, gender, time when the orderer is detected and weather at the time of past order.

The memory may store a pre-trained model to calculate a weight vector, the weight vector may represent the weight for each current input attribute as each component, and reading the read vector may include calculating a similarity vector by applying the weight vector to each similarity calculation result between each current input attribute and each past input attribute, and reading the read vector based on a calculation result between the similarity vector and the one or more vectors stored in the memory.

Reading the read vector may include calculating the similarity vector based on the calculation result of multiplying each similarity calculation result between each current input attribute and each past input attribute by each element of the weight vector, and reading the read vector based on the calculation result of multiplying the similarity vector by each component of the one or more vectors stored in the memory.

The pre-trained model may be trained to minimize a difference between the recommended product and the orderer's actually selected product based on a preset loss function.

The method may further comprise storing the input vector and the recommended product into the memory.

The storing may include storing a pair of the current input vector and the recommended product at a first location at which the matching vector is stored in the memory, when the current input vector matches any one of the one or more vectors in the memory.

The storing may include storing the current input vector and the recommended product at a second location, when none of the one or more vectors in the memory match the current input vector, and the second location may be determined based on a recently used vector representing a vacant period during which there is no access from a last access of each location of the memory.

The recently used vector may be updated by multiplying the recently used vector by a parameter having a value of 0 or greater and less than 1 to reduce a component included in the recently used vector over time, when the current input vector is stored in the memory, and the component of the recently used vector corresponding to the location of the memory at which the current input vector is stored may be updated to a maximum value.

The storing may include storing the current input vector and the orderer's actually selected product into the memory, when the orderer's actually selected product is different from the recommended product.

A kiosk for providing a recommendation service according to an embodiment comprising: a receiver configured to receive a current input vector including one or more current input attributes representing a context feature of a current order status; a reader configured to read a read vector including an orderer's past ordered product by applying a weight corresponding to the current input attribute to a similarity calculation result between each current input attribute of the current input vector and each past input attribute stored in memory; and a display configured to display a recommended product on a screen of the kiosk occupied by the orderer based on the past ordered product in the read vector.

The one or more current input attributes may include at least some of the orderer's facial identity, look, emotion, age, gender, time when the orderer is detected and weather at the time of current order, and each past input attribute may include at least some of the orderer's facial identity, look, emotion, age, gender, time when the orderer is detected and weather at the time of past order.

The memory may store a pre-trained model to calculate a weight vector, the weight vector may represent the weight for each current input attribute as each component, and the reader may calculate a similarity vector by applying the weight vector to each similarity calculation result between each current input attribute and each past input attribute, and read the read vector based on a calculation result between the similarity vector and the one or more vectors stored in the memory.

The reader may calculate the similarity vector based on the calculation result of multiplying each similarity calculation result between each current input attribute and each past input attribute by each element of the weight vector, and read the read vector based on the calculation result of multiplying the similarity vector by each component of the one or more vectors stored in the memory.

The pre-trained model may be trained to minimize a difference between the recommended product and the orderer's actually selected product based on a preset loss function.

The kiosk may further comprise a storage to store the input vector and the recommended product into the memory.

The storage may store the pair of the current input vector and the recommended product at a first location at which the matching vector is stored in the memory, when the current input vector matches any one of the one or more vectors in the memory.

The storage may store the current input vector and the recommended product at a second location, when none of the one or more vectors in the memory match the current input vector, and the second location may be determined based on a recently used vector representing a vacant period during which there is no access from a last access of each location of the memory.

The recently used vector may be updated by multiplying the recently used vector by a parameter having a value of 0 or greater and less than 1 to reduce a component included in the recently used vector over time, when the current input vector is stored in the memory, and the component of the recently used vector corresponding to the location of the memory at which the current input vector is stored may be updated to a maximum value.

The storage may store the current input vector and the orderer's actually selected product into the memory, when the orderer's actually selected product is different from the recommended product.

Memory architecture according to an embodiment, with memory which stores a pair of an input attribute representing an order status of each orderer at the time of order and a product ordered by each orderer, comprising: receiving a current input vector including one or more current input attributes representing a context feature of a current order status; reading a read vector including a past ordered product of each orderer by applying a weight corresponding to the current input attribute to a similarity calculation result between each current input attribute of the current input vector and each past input attribute stored in the memory; and storing a pair of the current input vector and the past ordered product in the read vector into the memory.

The one or more current input attributes may include at least some of the orderer's facial identity, look, emotion, age, gender, time when the orderer is detected and weather at the time of current order, and each past input attribute may include at least some of the orderer's facial identity, look, emotion, age, gender, time when the orderer is detected and weather at the time of past order.

The memory may store a pre-trained model to calculate a weight vector, the weight vector may represent the weight for each current input attribute as each component, and reading the read vector may include: calculating a similarity vector by applying the weight vector to each similarity calculation result between each current input attribute and each past input attribute; and reading the read vector based on a calculation result between the similarity vector and the one or more vectors stored in the memory.

Reading the read vector may including: calculating the similarity vector based on the calculation result of multiplying each similarity calculation result between each current input attribute and each past input attribute by each element of the weight vector; and reading the read vector based on the calculation result of multiplying the similarity vector by each component of the one or more vectors stored in the memory.

The pre-trained model may be trained to minimize a difference between the past ordered product and the orderer's actually selected product based on a preset loss function.

The memory architecture may further comprise storing the input vector and the past ordered product into the memory.

The storing may include storing the pair of the current input vector and the past ordered product at a first location at which the matching vector is stored in the memory, when the current input vector matches any one of the one or more vectors in the memory.

The storing may include storing the current input vector and the past ordered product at a second location, when none of the one or more vectors in the memory match the current input vector, and the second location may be determined based on a recently used vector representing a vacant period during which there is no access from a last access of each location of the memory.

The recently used vector may be updated by multiplying the recently used vector by a parameter having a value of 0 or greater and less than 1 to reduce a component included in the recently used vector over time, when the current input vector is stored in the memory, and the component of the recently used vector corresponding to the location of the memory at which the current input vector is stored may be updated to a maximum value.

The storing may include storing the current input vector and the orderer's actually selected product into the memory, when the orderer's actually selected product is different from the past ordered product.

### Advantageous Effects

The disclosed embodiments may provide orderers with recommended menus using the orderers' ordering histories stored in the memory.

The disclosed embodiments may provide recommended menus reflecting the context feature of an external environment using a neural network built in the memory.

The disclosed embodiments may provide an emotional conversational kiosk capable of interacting with orderers using the context feature.

The disclosed embodiments may efficiently use the memory space by memorizing the oldest memory location through the recently used vector.

The disclosed embodiments may provide hybrid memory architecture with different attributes of read and write operations.

### DESCRIPTION OF DRAWINGS

FIG. 1 is a block diagram illustrating a kiosk for providing a recommendation service according to an exemplary embodiment.

FIG. 2 is a block diagram illustrating a kiosk for providing a recommendation service according to an additional exemplary embodiment.

FIG. 3 is a block diagram illustrating a kiosk for providing a recommendation service according to an additional exemplary embodiment.

FIG. 4 is a flowchart illustrating a method for providing a recommendation service based on a kiosk according to an exemplary embodiment.

FIG. 5 is a flowchart illustrating a method for providing a recommendation service based on a kiosk according to an additional exemplary embodiment.

FIG. 6 is a flowchart illustrating memory architecture according to an exemplary embodiment.

FIG. 7 is a flowchart illustrating memory architecture according to an additional exemplary embodiment.

### BEST MODE

The terms as used herein are general terms selected as those being now used as widely as possible in consideration of functions, but they may differ depending on the intention of those skilled in the art or the convention or the emergence of new technology. Additionally, in certain cases, there may be terms arbitrarily selected by the applicant, and in this case, the meaning will be described in the corresponding description part of the specification. Accordingly, it should be noted that the terms as used herein should be interpreted based on the substantial meaning of the terms and the context throughout the specification, rather than simply the name of the terms.

Additionally, the embodiments described herein may have aspects of entirely hardware, partly hardware and partly software, or entirely software. The term “unit”, “module”, “device”, “server” or “system” as used herein refers to a computer related entity such as hardware, a combination of hardware and software, or software. For example, the unit, module, device, server or system may refer to hardware that makes up all or part of a platform and/or software such as an application for running the hardware.

Hereinafter, the embodiments will be described in detail with reference to the accompanying drawings and the description made in the accompanying drawings, but the scope of the claimed subject matter is not restricted or limited by the embodiments.

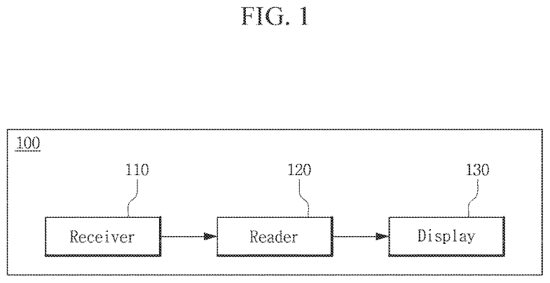

FIG. 1 is a block diagram illustrating a kiosk 100 for providing a recommendation service according to an exemplary embodiment.

Referring to FIG. 1, the kiosk 100 for providing a recommendation service includes a receiver 110, a reader 120 and a display 130.

According to an embodiment, the receiver 110, the reader 120 and the display 130 may be implemented using one or more physically separated devices, or may be implemented by one or more processors or a combination of one or more processors and software, and as opposed to the shown example, they may not be distinctly separated from each other in specific operations.

The receiver 110 is configured to receive a current input vector including one or more current input attributes representing the context feature of the current order status.

In this instance, the current input attribute may be configured to represent factors that may affect an orderer's product selection as a vector, and for example, the current input attribute may represent the features related to at least some of the orderer's facial identity, look, emotion, age, gender, the time when the orderer is detected and weather as a binary vector.

According to an embodiment, the receiver 110 may acquire the current input attribute from the orderer's image captured by a camera (not shown) provided in the kiosk 100 for providing a recommendation service, or a value processed by other module.

For example, the orderer's emotion may be recognized based on the orderer's facial expression and voice. The kiosk 100 for providing a recommendation service may acquire the attribute representing the orderer's emotion as a vector by inputting the face image showing the facial expression and/or voice to a pre-trained emotion recognizer.

In a specific example, the receiver 110 may receive a first current input attribute representing, as a binary vector, any one of anger, hatred, fear, happiness, sadness, surprise and neutrality as the orderer's emotion.

In another example, the receiver 110 may receive a second current input attribute representing, as a binary vector, any one of children-adolescents (age 18 and under), young adults (from age 19 to 29), middle-aged adults (from age 30 to 49), elderly adults (from age 50 to 64), older people (age 65 and above) as the orderer's age.

In still another example, the receiver 110 may receive a third current input attribute representing, as a binary vector, any one of male, female and unknown as the orderer's gender.

In yet another example, the receiver 110 may receive a fourth current input attribute representing, as a binary vector, any one of 6 o'clock, 12 o'clock, 18 o'clock and 24 o'clock as the time when the orderer is detected.

Meanwhile, the orderer's emotion, age, gender and the time when the orderer is detected are not necessarily limited to the above-described examples, and a variety of other emotions, ages, genders and times may be represented. Additionally, the orderer's emotion, age, gender and the time when the orderer is detected may be represented not only in the discrete form as described for illustrative purposes, but also a continuous value represented numerically.

The reader 120 is configured to read a read vector including the orderer's past ordered product by applying a weight corresponding to the current input attribute to the similarity calculation result between each current input attribute of the current input vector and each past input attribute stored in the memory.

According to an embodiment, the reader 120 may calculate a similarity vector by applying a weight vector to each similarity calculation result between each current input attribute and each past input attribute, and read the read vector based on the calculation result between the similarity vector and one or more vectors stored in the memory.

According to an embodiment, the reader 120 may calculate the similarity vector based on the calculation result of multiplying each similarity calculation result between each current input attribute and each past input attribute by each element of the weight vector, and read the read vector based on the calculation result of multiplying the similarity vector by each component of one or more vectors stored in the memory.

Specifically, the reader 120 may calculate the similarity vector using the following Equation 1.

$${( {s}_{t} )}_{i} = {\sum }_{j = 1}^{A} {w}_{t}^{j} \frac{{M}_{i} ( j ) k ( j )}{\vert {M}_{i} ( j ) \vert \vert k ( j ) \vert} \\ {s}_{t} = [ {( {s}_{t} )}_{1} … {( {s}_{t} )}_{N} ] \qquad [ Equation 1 ]$$

In this instance, Mᵢ(j) is the j^{th} current input attribute of the current input vector in the column vector of the memory corresponding to the i^{th} memory location, k(j) is the partial column vector corresponding to the j^{th} current input attribute in the current input vector, wₜ^{j} is the weight for the j^{th} current input attribute, (sₜ)ᵢ is the i^{th} component of the similarity vector, sₜ is the similarity vector, and A is the total number of current input attributes.

In this instance, the reader 120 may calculate Mᵢ(j) using the following Equation 2.

Mᵢ(j)=(Mₜ)_{i,1+Σ}_{ₖ₌₁}_{^{j−2}}ₐ_{ₖ}_{^{j}}_{Σ}_{ₖ₌₂}_{^{j}}ₐ_{ₖ} [Equation 2]

Here, Mᵢ(j) is the j^{th} current input attribute of the current input vector in the column vector of the memory corresponding to the i^{th} memory location, Mₜ is the matrix stored in the memory at the time of the current order, and aₖ is the dimension of the k^{th} current input attribute.

In this instance, the reader 120 may calculate using the following Equation 3.

k(j)=(kₜ^{r})_{1+Σ}_{ₖ₌₂}_{^{j−2}}ₐ_{ₖ}_{Σ}_{ₖ₌₁}_{^{j}}ₐ_{ₖ} [Equation 3]

In this instance, k(j) is the partial column vector corresponding to the j^{th} current input attribute in the current input vector, k_{c}^{r} is the read vector determined at the time of the current order, and aₖ is the dimension of the k^{th} current input attribute.

According to an embodiment, the reader 120 may calculate a pre-read vector by multiplying the similarity vector by each component of one or more vectors stored in the memory, and calculate the read vector by summing each column of the pre-read vector.

In other words, the reader 120 may calculate the read vector using the following Equation 4.

$${r}_{t} = {[ {\sum }_{i = 1}^{N} {( {R}_{t} )}_{i , 1} … {\sum }_{i = 1}^{N} {( {R}_{t} )}_{i , X + Y} ]}^{T} \qquad [ Equation 4 ]$$

Here, rₜ is the read vector, R is the pre-read vector, and N is the size of the memory.

According to an embodiment, the weight may be acquired from a pre-trained model stored in the memory.

According to an embodiment, the pre-trained model may be trained to minimize a difference between the recommended product and the orderer's actually selected product based on a preset loss function, and may output the weight vector.

The weight vector may represent the weight for each current input attribute as each component.

In this instance, the pre-trained model may calculate the weight vector using the following Equation 5.

[wₜ¹ . . . wₜ^{a}]^{T}=σ(N(kₜ^{r};θ)) [Equation 5]

Here, wₜ^{a} is the weight for the a^{th} current input attribute, σ is a soft max function, N is the neural network, k_{c}^{r} is the read vector, and a is the trainable weight of the neural network.

For example, in case that the current input attribute includes the orderer's emotion at the time of order and the time when the orderer is detected, and the pre-trained model determines that the orderer makes emotional product selections, the pre-trained model may output the weight vector as (1.0, 0.0).

That is, the pre-trained model may determine which input attribute to stop in determining a recommended product and output the weight vector.

The display 130 is configured to display the recommended product on the screen of the kiosk occupied by the orderer based on the past ordered product in the read vector.

According to an embodiment, the display 130 may display an emotional message including the past ordered product on the screen of the kiosk.

In this instance, the emotional conversation may be a conversation related to the input attribute stored in the memory. For example, the emotional conversation may include a message for recommending a product related to the orderer's look, the orderer's emotion, the time when the orderer is detected and weather.

In a specific example, the display 130 may display the emotional conversation related to the orderer's emotion including recommended product: Lungo forte on the screen of the kiosk.

“It was a LUNGO FORTE when you looked HAPPY, right?”

According to an embodiment, the display 130 may display all available menus through the kiosk.

Specifically, the display 130 may display all available products through the kiosk, when the orderer input including the orderer's intention to unselect the recommended product is received.

Although the foregoing description discloses that the recommended product is displayed on the kiosk screen, this is provided for illustrative purposes and the present disclosure is not necessarily limited thereto. The kiosk as used herein is a device that is shared by multiple people, and should be interpreted as including any device that provides a service including a process of selecting any one of multiple contents.

Meanwhile, in the above-described example, the display and the orderer input may be performed through all methods for interaction with the orderer, for example, chatbot, touch, voice conversation and/or Text To Speech (TTS) and avatar based gesture recognition according to embodiments.

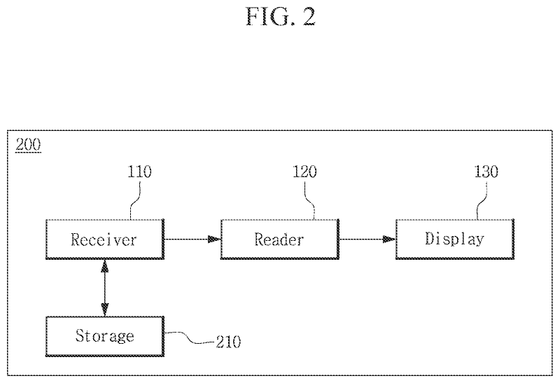

FIG. 2 is a block diagram illustrating a kiosk 200 for providing a recommendation service according to an additional exemplary embodiment.

Referring to FIG. 2, the kiosk 200 for providing a recommendation service according to an embodiment further comprises a storage 210.

In the example shown in FIG. 2, the receiver 110, the reader 120 and the display 130 have the same configuration as the configuration shown in FIG. 1, and overlapping descriptions are omitted.

According to an embodiment, the storage 210 may be implemented using one or more physically separated devices, or may be implemented by one or more processors or a combination of one or more processors and software, and as opposed to the shown example, they may not be distinctly separated from each other in specific operations.

The storage 210 may store a pair of the current input vector and the recommended product in the memory.

According to an embodiment, the storage 210 may store a store vector including the pair of the current input vector and the recommended product at a first location at which the matching vector is stored in the memory when the current input vector matches any one of the one or more vectors in the memory.

According to another embodiment, the storage 210 may store the store vector including the pair of the current input vector, when none of the one or more vectors in the memory match the current input vector, and the recommended product at a second location.

Meanwhile, the storage 210 may store the store vector including the pair of the current input vector and the orderer's actually selected product at the second location, when the orderer's actually selected product is different from the recommended product.

In other words, the storage 210 may store the current input vector and the recommended product in the specific location of the memory using the following Equation 6.

$${n}_{t}^{w} = \{ \begin{matrix}{n}_{t}^{r} & if max ( \{ {( {s}_{t} )}_{i} \} ) = 1 \\ {n}_{t}^{new} & otherwise\end{matrix} \qquad [ Equation 6 ]$$

In this instance, nₜ^{w} may be the location at which the store vector will be stored in the memory, nₜ^{r} may be the first location, and nₜ^{new} may be the second location.

Specifically, the second location may be determined based on a recently used vector.

According to an embodiment, the second location may be determined based on an index of the minimum component in the recently used vector.

The recently used vector is a vector representing the number of accesses for each memory location, and may represent a vacant period during which there is no access from the last access of each location of the memory.

According to an embodiment, the recently used vector may be updated by multiplying it by a parameter having a value of 0 or greater and less than 1 to reduce the component included in the recently used vector over time, when the current input vector is stored in the memory, and the component of the recently used vector corresponding to the location of the memory at which the current input vector is stored may be updated to the maximum value.

In other words, the recently used vector may be updated using the following Equation 7.

$$\{ \begin{matrix}{u}_{t + 1} = τ {u}_{t} \vert 0 \leq τ < 1 \\ {( {u}_{t + 1} )}_{{n}_{t}^{w}} = 1\end{matrix} \qquad [ Equation 7 ]$$

In this instance, uₜ₊₁ is the recently used vector updated after the current order, uₜ is the recently used vector used at the time of the current order, τ is the time decay parameter, (uₜ₊₁)ₙ_{ₜ}_{^{w}} is the nₜ^{wth} component of the recently used vector updated after the current order, and nₜ^{w} is the location of the memory at which the current input vector is stored.

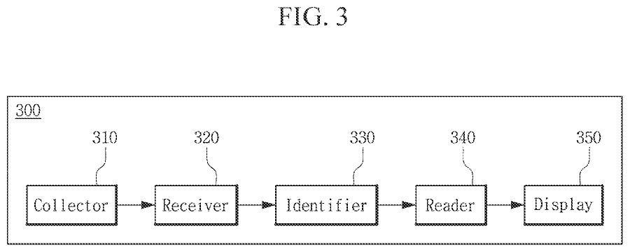

FIG. 3 is a block diagram illustrating a kiosk 300 for providing a recommendation service according to an additional exemplary embodiment.

Referring to FIG. 3, the kiosk 300 for providing a recommendation service according to an embodiment further comprises a collector 310 and an identifier 330.

In the example shown in FIG. 3, a receiver 320, a reader 340 and a display 350 have the same configuration as the configuration shown in FIG. 1, and overlapping descriptions are omitted.

According to an embodiment, the collector 310 and the identifier 330 may be implemented using one or more physically separated devices, or may be implemented by one or more processors or a combination of one or more processors and software, and as opposed to the shown example, they may not be distinctly separated from each other in specific operations.

The collector 310 may collect prior consent for collection and storage of the orderer's personal information.

According to an embodiment, the collector 310 may collect the orderer's prior consent for collection and storage of the personal information including the orderer's facial identity, look, emotion, age, gender and ordering history.

For example, the collector 310 may collect the orderer's prior consent by recognizing a touch of a preset area of the kiosk, the orderer's voice generated through interaction with the kiosk and a TTS based text conversation and/or an avatar based gesture.

Although it is described that the personal information includes facial identity, look, emotion, age, gender and ordering history, this is provided for illustrative purposes and the personal information is not necessarily limited thereto. The personal information is intended to include information for identifying the information subject.

The identifier 330 may identify the orderer based on the similarity calculation result between each current input attribute of the current input vector and each past input attribute stored in the memory.

Specifically, the identifier 330 may identify the orderer based on the most similar past input attribute determined according to the similarity calculation result between each current input attribute of the current input vector and each past input attribute stored in the memory.

For example, the identifier 330 may determine the most similar facial identity attribute in the past input attribute according to the similarity calculation result between the orderer's facial identity attribute in the current input attribute and the orderer's facial identity attribute in the past input attribute pre-stored in the memory, and identify the orderer based on the determined most similar facial identity attribute in the past input attribute.

Accordingly, the identifier 330 may identify the orderer who currently occupies the kiosk 300 for providing a recommendation service without signing up or any external input identification information, thereby enhancing the ordering convenience.

Additionally, the receiver 320 and the identifier 330 may perform the functions on the premise of prior consent collected for each orderer. That is, the receiver 320 may receive the current input vector only when the orderer's prior consent is collected. That is, the identifier 330 may identify the orderer only when the orderer's prior consent is collected in advance.

Here, the collected prior consent may refer to subsequent to initial recognition of the orderer's prior consent by the collector 310. In other words, the orderer's first prior consent may be regarded as including prior consent required for each subsequent order.

Although it is described that the orderer's first prior consent includes prior consent on the subsequent visit, this is provided for illustrative purposes and the first prior consent may be variously set according to embodiments, and for example, effective only on orders made after a preset number of visits.

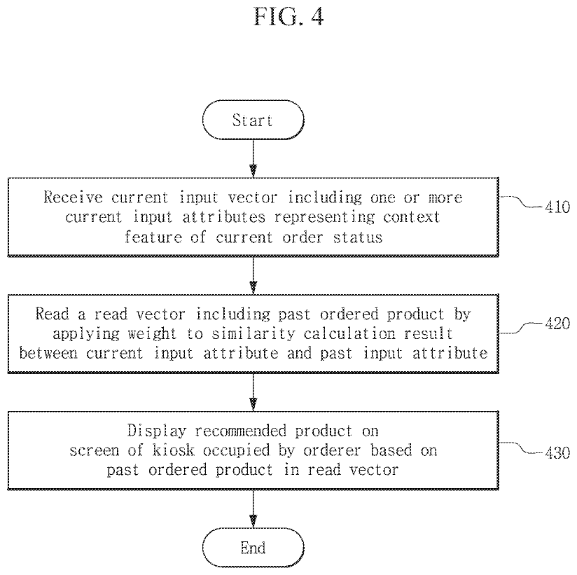

FIG. 4 is a flowchart illustrating a method for providing a recommendation service based on a kiosk according to an exemplary embodiment.

The method shown in FIG. 4 may be performed by the kiosk 100 for providing a recommendation service shown in FIG. 1.

Referring to FIG. 4, first, the kiosk 100 for providing a recommendation service receives the current input vector including one or more current input attributes representing the context feature of the current order status (410).

Subsequently, the kiosk 100 for providing a recommendation service reads the read vector including the orderer's past ordered product by applying the weight corresponding to the current input attribute to the similarity calculation result between each current input attribute of the current input vector and each past input attribute stored in the memory (420).

Subsequently, the kiosk 100 for providing a recommendation service displays the recommended product on the screen of the kiosk occupied by the orderer based on the past ordered product in the read vector (430).

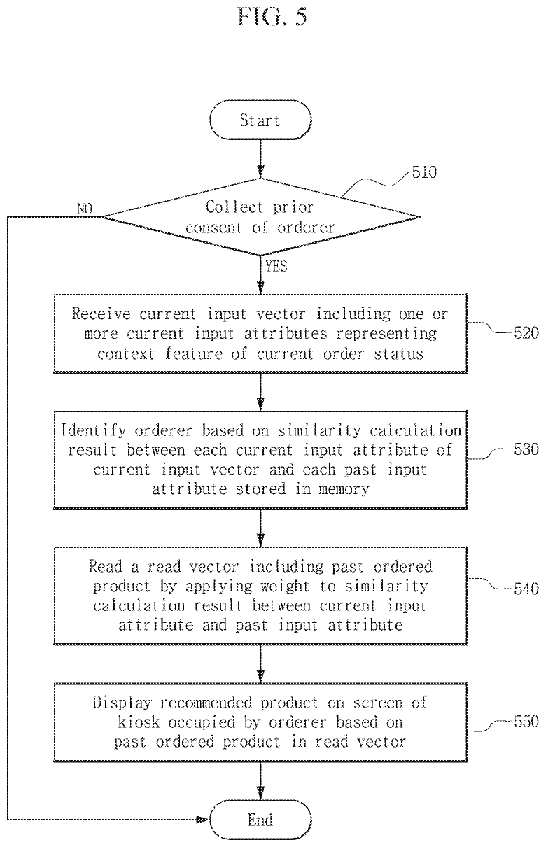

FIG. 5 is a flowchart illustrating a method for providing a recommendation service based on a kiosk according to an additional exemplary embodiment.

The method shown in FIG. 5 may be performed by the kiosk 300 for providing a recommendation service shown in FIG. 3.

Referring to FIG. 5, first, the kiosk 300 for providing a recommendation service determines whether prior consent for collection and storage of the orderer's personal information was collected (510).

Subsequently, when the kiosk 300 for providing a recommendation service determines that the orderer's prior consent was collected, the kiosk 300 for providing a recommendation service receives the current input vector including one or more current input attributes representing the context feature of the current order status (520).

Subsequently, the kiosk 300 for providing a recommendation service identifies the orderer based on the similarity calculation result between each current input attribute of the current input vector and each past input attribute stored in the memory (530).

Subsequently, the kiosk 300 for providing a recommendation service reads the read vector including the orderer's past ordered product by applying the weight corresponding to the current input attribute to the similarity calculation result between each current input attribute of the current input vector and each past input attribute stored in the memory (540).

Subsequently, the kiosk 300 for providing a recommendation service displays the recommended product on the screen of the kiosk occupied by the orderer based on the past ordered product in the read vector (550).

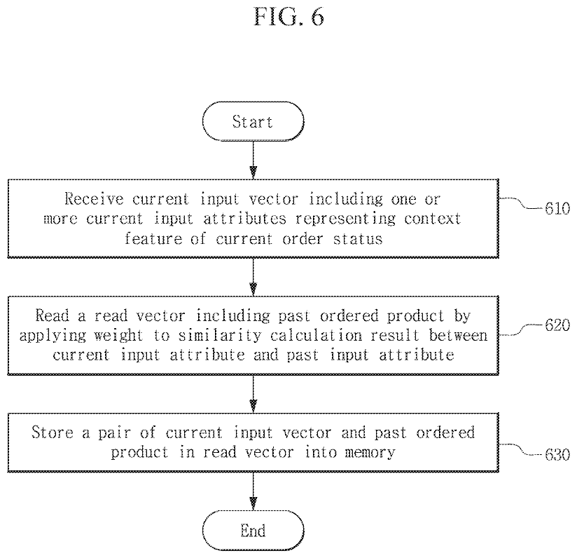

FIG. 6 is a flowchart illustrating memory architecture according to an exemplary embodiment.

The method shown in FIG. 6 may be performed by the kiosk 200 for providing a recommendation service shown in FIG. 2.

Referring to FIG. 6, first, the kiosk 200 for providing a recommendation service receives the current input vector including one or more current input attributes representing the context feature of the current order status (610).

Subsequently, the kiosk 200 for providing a recommendation service reads the read vector including each orderer's past ordered product by applying the weight corresponding to the current input attribute to the similarity calculation result between each current input attribute of the current input vector and each past input attribute stored in the memory (620).

Subsequently, the kiosk 200 for providing a recommendation service stores a pair of the current input vector and the past ordered product in the read vector into the memory (630).

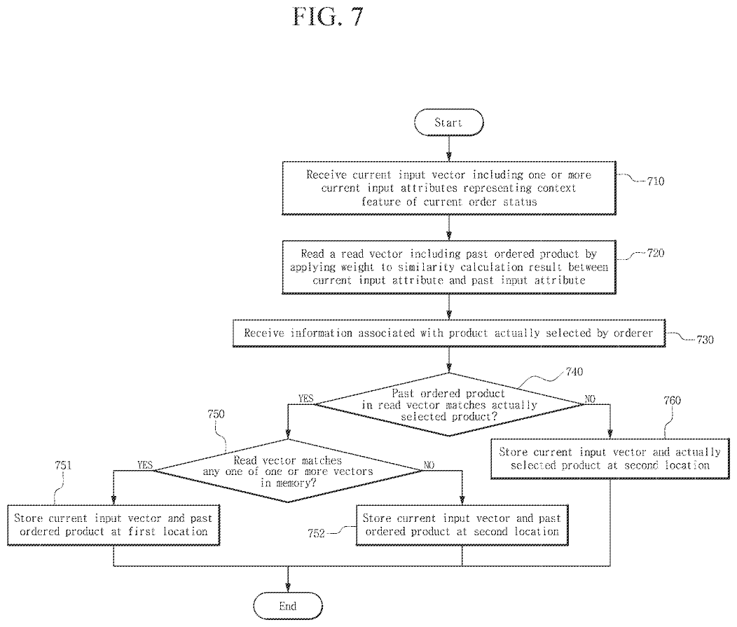

FIG. 7 is a flowchart illustrating memory architecture according to an additional exemplary embodiment.

The method shown in FIG. 7 may be performed by the kiosk 200 for providing a recommendation service shown in FIG. 2.

Referring to FIG. 7, first, the kiosk 200 for providing a recommendation service receives the current input vector including one or more current input attributes representing the context feature of the current order status (710).

Subsequently, the kiosk 200 for providing a recommendation service reads the read vector including each orderer's past ordered product by applying the weight corresponding to the current input attribute to the similarity calculation result between each current input attribute of the current input vector and each past input attribute stored in the memory (720).

Subsequently, the kiosk 200 for providing a recommendation service receives information associated with the orderer's actually selected product (730).

Subsequently, the kiosk 200 for providing a recommendation service determines whether the past ordered product in the read vector matches the orderer's actually selected product (740).

Subsequently, when the kiosk 200 for providing a recommendation service determines that the past ordered product in the read vector matches the orderer's actually selected product, the kiosk 200 for providing a recommendation service determines whether the current input vector matches any one of the one or more vectors in the memory (750).

Subsequently, when the kiosk 200 for providing a recommendation service determines that the current input vector matches any one of the one or more vectors in the memory, the kiosk 200 for providing a recommendation service stores, as a feedback on the determination, a pair of the current input vector and the recommended product at the first location at which the matching vector is stored in the memory (751).

On the contrary, when the kiosk 200 for providing a recommendation service determines that none of the one or more vectors in the memory match the current input vector, the kiosk 200 for providing a recommendation service stores, as a feedback on determination, a pair of the current input vector and the recommended product at the second location (752).

In this instance, the second location is determined based on the recently used vector representing a vacant period during which there is no access from the last access of each location of the memory.

Meanwhile, when the kiosk 200 for providing a recommendation service determines that the past ordered product in the read vector is different from the orderer's actually selected product, the kiosk 200 for providing a recommendation service stores, as a feedback on the determination, the current input vector and the orderer's actually selected product in the memory (760).

In FIGS. 4 to 7, the method is described with reference to the flowchart presented in the drawings. Although the method is shown and described as a series of blocks for illustrative purposes, the present disclosure is not limited to the sequence of the blocks, and some blocks may be executed at the same time or in other sequences that are different from those shown and described herein, and a variety of other branch, flow path and block sequences that achieves the same or similar results may be implemented. Additionally, all the blocks shown to implement the method described herein may not be required.

Further, the method according to an embodiment of the present disclosure may be implemented in the form of a computer program for performing a series of processes, and the computer program may be recorded in computer-readable recording media. Examples of the computer-readable recording media include hardware devices specially designed to store and execute the program instructions, for example, magnetic media such as hard disk, floppy disk and magnetic tape, optical media such as CD-ROM and DVD, magneto-optical media such as floptical disk, and ROM, RAM and flash memory.

While the present disclosure has been hereinabove described with reference to the embodiments, it will be understood by those having ordinary skill in the corresponding technical field that various modifications and changes may be made to the present disclosure without departing from the spirit and scope of the present disclosure set forth in the appended claims.

### DETAILED DESCRIPTION OF MAIN ELEMENTS

100: Kiosk for providing a recommendation service
110: Receiver
120: Reader
130: Display
200: Kiosk for providing a recommendation service
210: Storage
300: Kiosk for providing a recommendation service
310: Collector
320: Receiver
330: Identifier
340: Reader
350: Display

1. A kiosk for providing a recommendation service, comprising:
a receiver configured to receive a current input vector including one or more current input attributes representing a context feature of a current order status;
a reader configured to read a read vector including an orderer's past ordered product by applying a weight corresponding to the current input attribute to a similarity calculation result between each current input attribute of the current input vector and each past input attribute stored in memory; and
a display configured to display a recommended product on a screen of the kiosk occupied by the orderer based on the past ordered product in the read vector.

2. The kiosk for providing a recommendation service according to claim 1, wherein the one or more current input attributes include at least some of the orderer's facial identity, look, emotion, age, gender, time when the orderer is detected and weather at the time of current order, and
wherein the each past input attribute includes at least some of the orderer's facial identity, look, emotion, age, gender, time when the orderer is detected and weather at the time of past order.

3. The kiosk for providing a recommendation service according to claim 1, wherein the memory stores a pre-trained model to calculate a weight vector,
wherein the weight vector is configured to represent the weight for each current input attribute as each component, and
wherein the reader is configured to calculate a similarity vector by applying the weight vector to each similarity calculation result between each current input attribute and each past input attribute, and read the read vector based on a calculation result between the similarity vector and the one or more vectors stored in the memory.

4. The kiosk for providing a recommendation service according to claim 3, wherein the reader is configured to calculate the similarity vector based on the calculation result of multiplying each similarity calculation result between each current input attribute and each past input attribute by each element of the weight vector, and read the read vector based on the calculation result of multiplying the similarity vector by each component of the one or more vectors stored in the memory.

5. The kiosk for providing a recommendation service according to claim 4, wherein the pre-trained model is trained to minimize a difference between the recommended product and the orderer's actually selected product based on a preset loss function.

6. The kiosk for providing a recommendation service according to claim 1, further comprising:
a storage configured to store a pair of the current input vector and the recommended product into the memory.

7. The kiosk for providing a recommendation service according to claim 6, wherein the storage is configured to store the pair of the current input vector and the recommended product at a first location at which the matching vector is stored in the memory, when the current input vector matches any one of the one or more vectors in the memory.

8. The kiosk for providing a recommendation service according to claim 6, wherein the storage is configured to store the current input vector and the recommended product at a second location, when none of the one or more vectors in the memory match the current input vector, and wherein the second location is determined based on a recently used vector representing a vacant period during which there is no access from a last access of each location of the memory.

9. The kiosk for providing a recommendation service according to claim 8, wherein the recently used vector is updated by multiplying the recently used vector by a parameter having a value of 0 or greater and less than 1 to reduce a component included in the recently used vector over time, when the current input vector is stored in the memory, and
wherein the component of the recently used vector corresponding to the location of the memory at which the current input vector is stored is updated to a maximum value.

10. The kiosk for providing a recommendation service according to claim 6, wherein the storage is configured to store the current input vector and the orderer's actually selected product into the memory, when the orderer's actually selected product is different from the recommended product.

11. Memory architecture with memory which stores a pair of an input attribute representing an order status of each orderer at the time of order and a product ordered by each orderer, comprising:
receiving a current input vector including one or more current input attributes representing a context feature of a current order status;
reading a read vector including a past ordered product of each orderer by applying a weight corresponding to the current input attribute to a similarity calculation result between each current input attribute of the current input vector and each past input attribute stored in the memory; and
storing a pair of the current input vector and the past ordered product in the read vector into the memory.

12. The memory architecture according to claim 11, wherein the one or more current input attributes include at least some of the orderer's facial identity, emotion, age, gender, time when the orderer is detected and weather at the time of current order, and
wherein the each past input attribute includes at least some of the orderer's facial identity, emotion, age, gender, time when the orderer is detected and weather at the time of past order.

13. The memory architecture according to claim 11, wherein the memory is configured to store a pre-trained model to calculate a weight vector,
wherein the weight vector is configured to represent the weight for each current input attribute as each component, and
reading the read vector including:
calculating a similarity vector by applying the weight vector to each similarity calculation result between each current input attribute and each past input attribute; and
reading the read vector based on a calculation result between the similarity vector and the one or more vectors stored in the memory.

14. The memory architecture according to claim 13, wherein the reading the read vector includes:
calculating the similarity vector based on the calculation result of multiplying each similarity calculation result between each current input attribute and each past input attribute by each element of the weight vector; and
reading the read vector based on the calculation result of multiplying the similarity vector by each component of the one or more vectors stored in the memory.

15. The memory architecture according to claim 14, wherein the pre-trained model is trained to minimize a difference between the past ordered product and the orderer's actually selected product based on a preset loss function.

16. The memory architecture according to claim 11, further comprising:
storing the current input vector and the past ordered product into the memory.

17. The memory architecture according to claim 16, wherein the storing includes storing the pair of the current input vector and the past ordered product at a first location at which the matching vector is stored in the memory, when the current input vector matches any one of the one or more vectors in the memory.

18. The memory architecture according to claim 16, wherein the storing includes storing the current input vector and the past ordered product at a second location, when none of the one or more vectors in the memory match the current input vector, and
wherein the second location is determined based on a recently used vector representing a vacant period during which there is no access from a last access of each location of the memory.

19. The memory architecture according to claim 18, wherein the recently used vector is updated by multiplying the recently used vector by a parameter having a value of 0 or greater and less than 1 to reduce a component included in the recently used vector over time, when the current input vector is stored in the memory, and
wherein the component of the recently used vector corresponding to the location of the memory at which the current input vector is stored is updated to a maximum value.

20. The memory architecture according to claim 16, wherein the storing includes storing the current input vector and the orderer's actually selected product into the memory, when the orderer's actually selected product is different from the past ordered product.
